(19) United States
(12) Patent Application Publication
(10) Pub. No.: US 2022/0306465 A1
(43) Pub. Date: Sep. 29, 2022

(54) Reducing Firing and CO2 Emissions in Primary Reformers and Direct Fired Furnaces

(71) Applicant: Vinod Kumar Arora, Katy, TX (US)

(72) Inventor: Vinod Kumar Arora, Katy, TX (US)

(21) Appl. No.: 17/702,721

(22) Filed: Mar. 23, 2022

Related U.S. Application Data
(60) Provisional application No. 63/165,172, filed on Mar. 24, 2021.

(51) Int. Cl. C01B 3/38; B01J 19/24

(52) U.S. Cl. CPC C01B 3/382; B01J 19/245; C01B 2203/0233; C01B 2203/085; C01B 2203/0811; C01B 2203/0866; B01J 2219/00132; B01J 2219/00157; B01J 2219/0009; C01B 2203/1235

(57) ABSTRACT

This disclosure relates installed or new synthesis gas (Syngas) production units and potential modifications to those units to reduce the firing requirements and significant emissions of CO₂ from those units with affordable capital expenditures.

### CROSS-REFERENCE TO RELATED APPLICATIONS

This application claims the benefit of U.S. Provisional application 63/165,172 filed Mar. 24, 2021. The aforementioned patent application is hereby incorporated by reference in its entirety into the present application to the extent consistent with the present application.

### FIELD

This disclosure relates to installed synthesis gas (Syngas) production units and potential modifications to those units to reduce the fuel firing requirements and proportionate reduction in CO₂ emissions from those units with minimum hardware changes, and low capital expenditures providing economically attractive payout.

### BACKGROUND

Reducing greenhouse gas emissions is rapidly becoming a necessity in every major industrial sector. The CO₂ emissions form the major part of greenhouse gases. This disclosure is mainly related to reducing the fuel firing and CO₂ emissions in the primary reformers and the direct fired reaction furnaces for producing synthesis gas (Syngas) used for the production of various chemicals including ammonia, methanol, hydrogen, ethylene, propylene, refined products and other petrochemicals. The embodiments presented in the disclosure are specific to the reforming sections in ammonia production facilities.

### A Brief on the Ammonia Process

To produce Ammonia, the first step is to convert the feed gas mixed with steam along with a small amount of hydrogen (called Mixed Feed) into Synthesis gas (a mixture of mostly CO & H₂) via an endothermic reforming reaction (CH₄+H₂O═CO+3H₂) using catalyst. The reforming in Ammonia plants is carried out in two steps using a primary reformer followed by a secondary reformer operated at a high pressure and temperature. The primary reformer is a tubular reactor and is directly fired with fuel gas to provide the heat of the endothermic reaction and is the major energy consumer and CO₂ emitter in ammonia plants. The secondary reformer is a fixed catalytic bed which performs additional reforming of the effluent from the Primary Reformer using the preheated process air. The oxygen molecule in the process air is completely combusted to provide the heat of the endothermic reaction and the nitrogen molecule in the air provides the needed nitrogen to later synthesize the mixture of hydrogen and nitrogen in the Synthesis section with an overall reaction as 0.88 CH₄+1.26 Air+1.24 H₂O=0.88 CO₂+2NH₃.

There are a number of technologies available to produce synthesis gas or syngas. Steam methane reforming is the most common. But there are a number of hydrocarbons other than methane that can be used in this process. These light hydrocarbon feedstocks and steam are converted in an endothermic reaction over a nickel catalyst. Heat to the reaction is provided in a radiant furnace.

Steam reforming of natural gas and other hydrocarbons produces synthesis gases that can be used to produce ammonia, methanol, hydrogen, OXO-syngas, and other chemicals.

The light hydrocarbon—steam reforming process can be described by two main reactions:

CH₄+H₂O═CO+3H₂ ΔH=198 kJ/mol (1)

CO+H₂O═CO₂+3H₂ ΔH=−41 kJ/mol (2)

The first reaction is reforming itself, while the second is the water-gas shift reaction. Since the overall reaction is endothermic, some heat input is required. This is accomplished by combustion of natural gas or other fuels in the direct-fired furnace of the primary reformer. Reaction (1) favors high temperature and low pressure, and proceeds usually in the presence of a nickel-based catalyst.

Depending on the required composition of the syngas and its end use, the reforming section may include a primary reformer, secondary or autothermal reformer, pre-reformer, or a pre-convective reformer.

There is a large global installed base of synthesis gas production based on steam reforming of light hydrocarbons. They are characterized by high investment requirements and significant emissions of CO₂. Environmental concerns have led to an increased interest to upgrading these units to reduce CO₂ emissions while doing it while saving capital investment.

Upgrading these production units, provided by different companies requires novel techniques of integrating equipment into different existing processes and this disclosure proposes several embodiments for doing this based on minimizing capital expenditures while reducing both firing and CO₂ emissions.

### Key Options Attempted to Reduce CO₂ Emissions

To reduce the firing and the CO₂ emissions from the combustion in the Primary Reformers in Ammonia plants, a combination of the following different options were studied.
i. Efficiency Improvement
ii. Carbon capture for further use or sequestration
iii. Suitable Electrification using a carbon neutral power source
iv. Hydrogen sourcing using a carbon neutral power source

The last three options for complete ammonia plants are still not economically viable. The ammonia industry has taken a small step with incremental reduction in CO₂ emissions using a very expensive hydrogen sourced via electrolysis for existing Ammonia plants. A partial carbon capture from the flue gas of Primary Reformers has only been implemented in a handful of chemical plants, mostly where CO2 was used as a feedstock for the neighboring units.

The primary reformer is a direct fired tubular catalytic reactor. The firing provides the heat for the reforming reactions is typically carried at high pressure (10-700 psig) and high temperature (650-1700 F). The hot flue gases from the reaction chamber (radiant section) are routed to a convection section for heat recovery using heat transfer coils for various services including the preheating of the combustion air with a combustion air preheater.

The newly proposed embodiments of this disclosure are primarily to reduce the fuel firing and CO₂ emissions from the primary reformers and direct fired furnaces. The reduction in CO₂ emissions achieved is the same or higher than some of the current systems using an electrolysis process, or using an equivalent amount of carbon capture from the flue gases without accounting the cost of the sequestration (CCS), but at a much lower CAPEX and OPEX. For the purpose of the comparison, the size of the electrolysis system is based on the required amount of hydrogen addition to an existing ammonia plant to reduce the CO₂ emissions to the same level. The CCS size basis also used the degree of reduction in the CO₂ emissions.”

What is needed are approaches that can be applied to various existing syngas units which lower the firing rate on the reformers and reduce the CO₂ emissions from the overall process at acceptable capital expenditures.

### SUMMARY OF THE DISCLOSURE

This need is met by the disclosure of nine novel modifications or additions as described in this disclosure to existing or new production processes using a combination of measures to reduce the process duty of reforming to both reduce fuel firing and CO₂ emissions.

The novel modifications of this disclosure are shown and described in nine different embodiments (in FIGS. 2 to 10) of this disclosure.

### BRIEF DESCRIPTION OF THE DRAWINGS

FIG. 1 is a schematic drawing of the prior art of the process synthesis gas unit.

FIG. 2 is a schematic drawing of a first embodiment that includes additional preheating of combustion air to the radiant section of the primary reformer with an external electrical heater.

FIG. 3 is a schematic drawing of a second embodiment that includes the repurposing of the process air coils for additional preheating of the mixed feed before feeding to the reformer section while the process air is preheated in an external electrical heater.

FIG. 4 is a schematic drawing of a third embodiment that includes electrical preheating of process air to the secondary reformer and additional convection section heating of the process mixed feed, along with additional preheating of combustion air with an electrical heater to the radiant section of the primary reformer.

FIG. 5 is a schematic drawing of a fourth embodiment that includes the addition of a catalytic pre-reformer that accepts an electrically heated mixed feed and heats the pre-reformed mixed feed along with a mix of the balance process steam in the normal mixed feed convection coils in the convection section of the primary reformer before feeding that partially reformed gas to the primary reformer catalyst tubes.

FIG. 6 is a schematic drawing of a fifth embodiment that includes the addition of a catalytic pre-reformer that accepts an electrically heated mixed feed along with electrical heating of the process air to the secondary reformer along with additional preheating of pre-reformed mixed feed with addition of the balance process steam between the normal mixed feed convection coil along with the repurposed process air convection coil formally used to preheat process air.

FIG. 7 is a schematic drawing of a sixth embodiment that includes the addition of a catalytic pre-reformer in which the mixed feed to the pre-reformer is preheated with an adjusted process steam flow in the mixed feed coils in the convection section of the primary reformer. The effluent from the pre-reformer is then mixed with the balance of the process steam and is electrically preheated before feeding to the primary reformer.

FIG. 8 is a schematic drawing of a seventh embodiment that includes the addition of a catalytic pre-reformer in which the process steam flow to mixed feed is adjusted and the mixed feed flow is preheated in the mixed feed coil as well as through the former process air coil. The combined preheated mixed feed is then fed to the pre-reformer. The effluent from the pre-reformer is then mixed with the balance of the process steam and is electrically preheated before feeding to the primary reformer.

FIG. 9 is a schematic drawing of an eighth embodiment that includes the addition of a catalytic pre-reformer in which the process steam flow to mixed feed is suitably adjusted and the mixed feed flow is preheated in the mixed feed coil as well as the repurposed process air coil in the convection section before feeding to the pre-reformer. The effluent from the pre-reformer is then mixed with the balance of the process steam and is electrically preheated before feeding to the primary reformer, with the process air to the secondary reformer being preheated in an electric heater.

FIG. 10 is a schematic drawing of a ninth embodiment that includes the addition of an electric heater to further heat the preheated mixed feed stream coming out from the mixed feed convection coils and another electric heater to further heat the preheated process air stream coming out from the process air convection coils. An optional addition of electric heater to further heat the preheated combustion air stream coming out of the Air Preheater.

### DETAILED DESCRIPTION

In the following detailed description, some temperatures and pressures are presented to provide insight. These values can vary depending on the particular installed version of synthesis gas production and the relative size and design capability of the equipment. These temperatures and pressures should not be construed as limitations in this application.

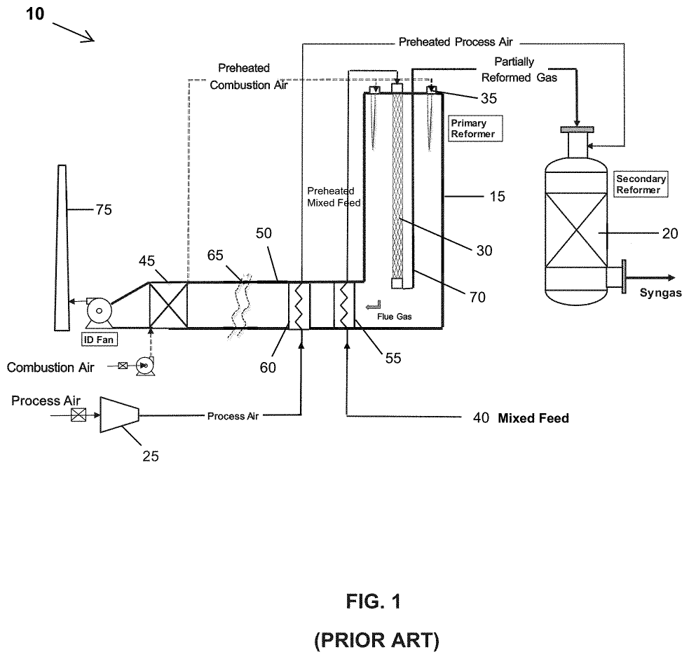

Referring first to FIG. 1, shown generally as 10, is a fairly typical prior art system for reforming of natural gas and/or other light hydrocarbons to produce synthesis gas for the production of ammonia, methanol, hydrogen, OXO-syngas, and other chemicals.

Depending on the required composition of the syngas and its end use, the reforming section may have a suitable combination to include a primary reformer, secondary or autothermal reformer, pre-reformer, and a pre-convective reformer. This prior art example features a primary reformer, and a secondary reformer only.

The primary reformer is a direct fired tubular catalytic reactor and is the major source of CO₂ emissions in syngas production facilities. A multitude of alloyed radiant tubes 30 filled with catalyst are used for the reforming reaction. These tubes are usually placed vertically within a refractory lined radiant section 15 as shown in FIG. 1.

The endothermic heat for the reforming reaction is provided by the direct firing of a fuel (not shown) through a set of burners 35 in the Radiant section of the Primary reformer. The fuel is a mix of mostly natural gas along with the purge gases available from the synthesis loop as well as small quantities of other purge streams from other unit operations within an ammonia plant. The burners 35 are supplied with fuel (not shown) and the combustion air either at the ambient or preheated conditions.

The major source of heat transfer in the radiant section is via radiant heat from the burner flames within the radiant section 15 to the preheated mixed feed 40 (a mixture of the feed gas, hydrogen and steam) flowing down through the catalyst tubes. The combustion air to the burners is normally preheated by an air preheater 45 installed in the convection section of the Primary Reformer. The location and the firing arrangement of the burners varies in different reformer designs and can be down-fired, side-fired, terrace-wall fired or bottom-up fired.

The flue gases leaving the radiant section is at a very high temperature (ranging between 1700 deg F. to 2200 deg F.) and are routed to the adjoining convection section 50 for heat recovery by preheating different process streams including the mixed feed in 55, process air for the secondary reformer in 60, steam superheating, feed preheating, boiler feedwater, steam generation, combustion air preheating etc. These are heated by passing them through a number of convection coils located in the convection section 50. There are various different arrangements of the convection section being horizontal or vertically upward and vertically downward along with an integrated auxiliary firing. The number and sequence of the different convection coils will differ in different primary reformer designs. However, mixed feed preheating 55, process air preheating 60, and the combustion air preheating 45 coils are common in most of the primary reformers used in ammonia plants. The Mixed Feed coil in some of the convection sections of the Reformer can be segmented as two or more sets of the coils and are usually referred as ‘Cold Leg’ and ‘Hot Leg’ of the Mixed feed coil. Similarly, the Process Air coil in some of the convection sections of the Reformer can be segmented as two or more sets of the coils and are usually referred as ‘Cold Leg’ an ‘Hot Leg’ of the Process Air coil. Additional possible coils are indicated as 65

The mixture of the clean feed gas and steam (referred as ‘mixed feed’ 40) is preheated in the convection coil 55 before routing to the catalyst tubes 30 in the radiant section of the primary reformer. The process air compressor (PAC) 25 supplies the compressed process air which is first preheated in convection coils 60 before routing to the secondary reformer.

A partially reformed gas mixture 70 leaves the primary reformer tubes at a high temperature and is routed to the secondary reformer for additional reforming and balancing of the H₂/N₂ ratio using the preheated process air coming from the convection coils 60 of the primary reformer. The outlet system arrangement from the primary reformer tubes to the secondary reformer varies depending on the design of the primary and secondary reformers and can use internal hot risers within the primary reformer and connected via an external transfer line to the bottom or top of the secondary reformer or cold or hot outlet manifolds connected via an external bottom transfer line to the bottom of the secondary reformer. The secondary reformer often uses a nickel-based catalyst bed 20 to accomplish the secondary reforming. The resulting Syngas from the secondary reformer leaves at a high temperature for further heat recovery and processing. The final flue gas exits the primary reformer through an Induced Draft (ID) fan exhausting the flue gas up the stack 75.

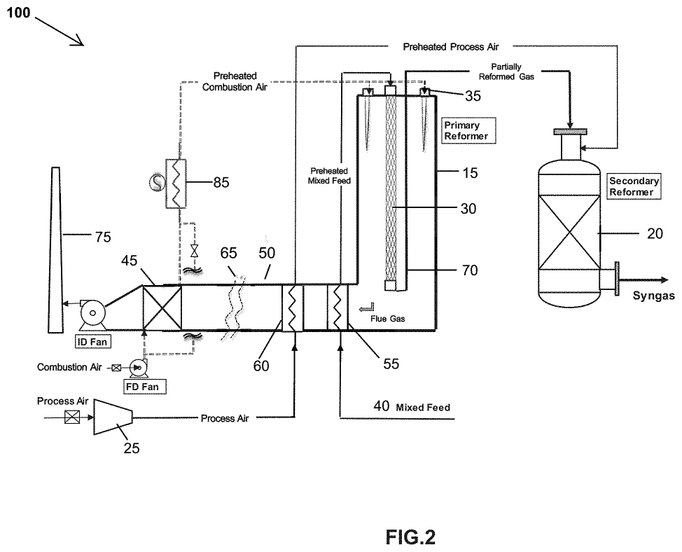

This disclosure describes nine embodiments that are aimed at reducing the incremental firing and CO2 emissions from the reforming furnaces. They are illustrated in FIGS. 2 thru 10.

### Embodiment 1

Referring now to FIG. 2, shown generally as 100, a first embodiment is described in which the addition of an electric heater 85 to raise the temperature of the combustion air (up to 1000 deg F.) is used to reduce the fuel firing in the primary reformer furnace and also reduce CO₂ emissions. The additional preheating of the combustion air could be done in series or parallel to the existing combustion air preheater 45. Note that a part of the combustion air may be bypassed around the air preheater 45 installed in the convection section of the Primary Reformer depending on pressure drop and operating conditions.

An increase in the preheat of the combustion air provides the following benefits as listed below.
i. Reduced Firing in Primary reformer
ii. Reduced Flue gas flow and CO₂ emissions
iii. Improved efficiency

An estimated reduction in the CO₂ emissions with embodiment 1 (FIG. 2) embodiment is up to 10% depending on the additional combustion air preheat up to 1000 degrees F., hydraulic constraints posed by combustion air Forced Draft (FD) fan, and firing capacity constraints of the burners and any other components specific to each plant. Any potential increment in the NOx can be mitigated with simple burner modifications and/or through the post combustion NOx reduction options.

For a similar reduction in CO₂ emissions, embodiment 1 of FIG. 2 needs less than 25% of the investment and the operating cost of the Electrolysis Hydrogen option with a much shorter project time frame to implement it. Also, the investment of embodiment 1 of FIG. 2 compared to the option of using an equivalent amount of CO₂ capture without the cost of the sequestration (CCS) is much less (less than 50%) with a shorter time frame of implementation.

It is important to note that this approach of using an electrical heater to the preheating of combustion air also can lead to important improvements in a number of other important industrial processes such as steam cracking of saturated hydrocarbons, charge heaters of propane dehydrogenation (PDH) units, Primary Reformers in Methanol and Hydrogen plants, and the refinery heaters.

### Embodiment 2

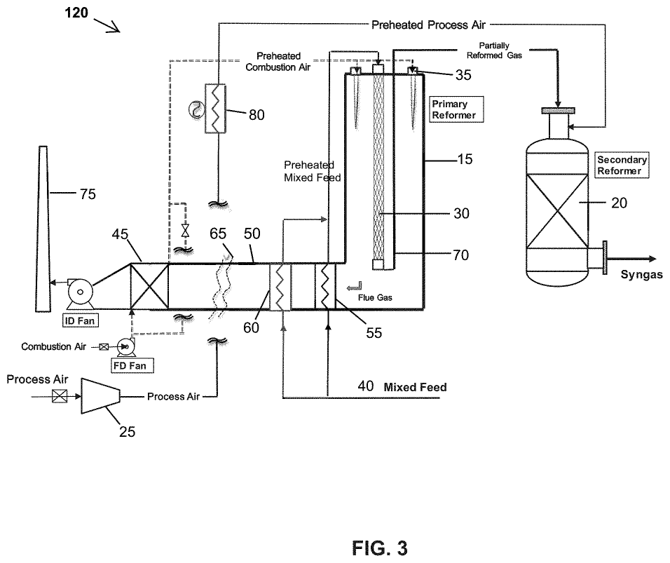

Referring next to FIG. 3, shown generally as 120, the second embodiment reduces the reaction duty of the primary reformer by sufficiently raising the temperature of the mixed feed 40 by partially or completely reusing or replacing the process air coil 60 in the convection section for additional preheating of the mixed feed. It has not been realized in the past that the existing process air convection coil can be fully or partially reused for additional preheating of Mixed Feed 40. It is normally not obvious and importantly there is rarely any spare convection space available to install any spare coils in that section. Even if some spare space is available in the convection section, it may not always be feasible to install additional coils due to insufficient heat profile or heat sink or various other reasons.

With a reduced process heat demand in the radiant tubes, the fuel firing in the radiant section of the primary reformer is also reduced with reduced CO₂ emissions. This combination will also reduce the process side pressure drop of the mixed feed preheat coil depending on the reconfiguration of the two coils. The mixed feed may be preheated with or without splitting its flow between the mixed feed coil and the process air coil along with a suitable flow bypass across the process air coil depending on the operating conditions, convection coils configurations and any other constraints in primary reformer.

Since the process air preheat coil in the convection section is now used for additional preheating of the mixed feed, the process air preheating is carried out externally with an electric heater 80. The electric heater permits further raising the temperature of the process air temperature (up to 1200 deg F.) and with a much-reduced pressure drop on the process air side. Note that a part of the combustion air may be bypassed around the air preheater 45 installed in the convection section of the Primary Reformer depending on pressure drop and operating conditions.

The combination of increased preheat of both the mixed feed stream and the process air stream along with reduced pressure drop provides the following benefits as listed below.
i. Reduced Reforming duty in the Radiant section of the primary reformer
ii. Reduced Firing in Primary reformer
iii. Reduced Flue gas flow and CO₂ and NOx emissions
iv. Higher conversion of the feed gas to Syngas
v. Reduced outlet temperature of the Radiant Tubes in the Primary Reformer
vi. Steam saving with reduced steam to carbon ratio in the Primary Reformer without sacrificing the overall conversion of the feed gas at the outlet of the Secondary Reformer
vii. Cooler operation of the expensive alloyed radiant tubes with longer life
viii. Improved feed conversion efficiency

An estimated reduction in the CO₂ emissions is up to 6% of the base operating level along with the above listed advantages.

For a similar reduction in CO₂ emissions, the embodiment of FIG. 3 needs less than 20% of the investment and the operating cost of the Electrolysis Hydrogen option with a much shorter project time frame to implement it. Also, the investment of the embodiment of FIG. 3 compared to the option of using the CO₂ capture without the cost of the sequestration (CCS) is much less (less than 50%) with a much shorter time frame of implementation.

### Embodiment 3

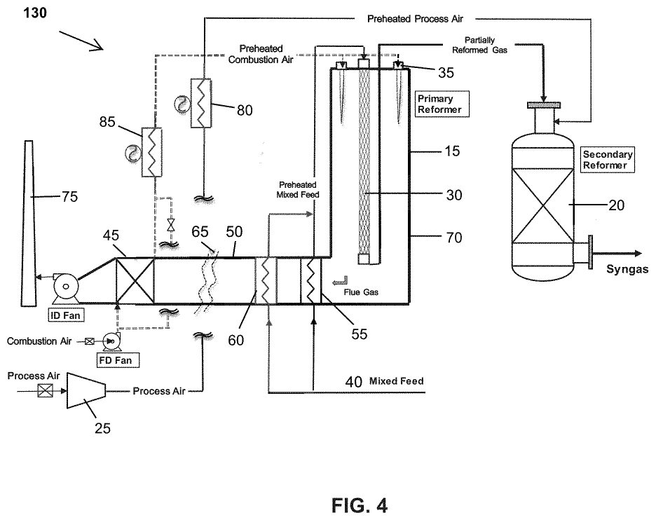

Referring now to FIG. 4, shown generally as 130, a third embodiment which could be considered a combination of embodiments 1 and 2. That is, both a process air electrical preheater 80 and a combustion air electrical preheater 85 are added. All the features and advantages listed for both embodiments applies for this embodiment. Note that a part of the combustion air may be bypassed around the air preheater 45 installed in the convection section of the Primary Reformer depending on pressure drop and operating conditions.

An estimated reduction in the CO₂ emissions will be up to 12% of the base operating level.

For a similar reduction in CO₂ emissions, embodiment 3 needs less than 45% of the investment and the operating cost of the Electrolysis Hydrogen option with a much shorter project time frame to implement it. Also, the investment of the embodiment of FIG. 4 compared to the option of using the CO₂ capture without the cost of the sequestration (CCS) will still be less and with a much shorter timeframe of implementation.

And as discussed in embodiment 2 the approach of embodiment 3 would have important contributions in a number of other important industrial processes such as steam cracking of saturated hydrocarbons, charge heaters of propane dehydrogenation (PDH) units, Primary Reformers in Methanol and Hydrogen plants, and refinery heaters.

### Embodiment 4

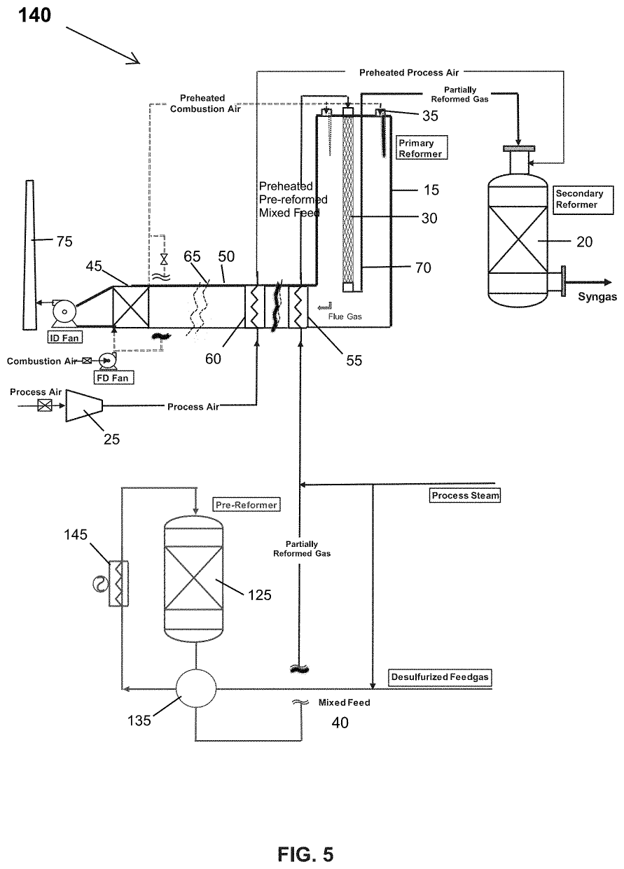

Referring now to FIG. 5, shown generally as 140, a fourth embodiment is described in which a new catalytic pre-reformer with a catalyst system 125 and an accompanying electric preheater 145 for the light hydrocarbon and steam mixed feed, thereby reducing the firing load on the primary reformer, reducing firing and lowering CO2 emissions. A pre-reformer is well known and has already been applied in reforming applications which provides pre-reforming at a lower temperature.

Typically, with a pre-reformer in the scheme, the process steam is usually split before and after the pre-reformer as shown in FIG. 5 to minimize or optimize the catalyst volume/size of the pre-reformer as the pre-reforming catalyst is much more expensive than reforming catalyst.

The feed gas into the pre-reforming section can be a mixture of various hydrocarbons and is always pretreated to remove potential catalyst poisons such a sulfur compounds or any other impurities. Hence often referred to as desulfurized feed gas. Then as shown some process steam is suitably added and the mixed feed is fed through a heat exchanger 135 and then heated electrically 145 (up to 1050 deg F.) and fed into the pre-reformer and through the catalyst bed 125. The partially reformed gas then is added with the balance of the process steam and passes through the convection coils 55 in the convection section before being fed through the radiant catalyst tubes 30 of the primary reformer. Note that a part of the combustion air may be bypassed around the air preheater 45 installed in the convection section of the Primary Reformer depending on pressure drop and operating conditions.

The combination of the pre-reformer along with increased preheat of both the mixed feed stream to primary reformer and the process air stream to the secondary reformer along with the reduced pressure drop provides the following benefits as listed below.
i. Reduced Reforming duty in the primary reformer
ii. Reduced Firing in Primary reformer
iii. Reduced Flue gas flow, CO₂ and NOX emissions
iv. Higher conversion of the feed gas to Syngas
v. Reduced outlet temperature of the Radiant Tubes in the Primary Reformer
vi. Steam saving with reduced steam to carbon ratio in the Primary Reformer without sacrificing the overall conversion of the feed gas at the outlet of the Secondary Reformer
vii. Cooler operation of the expensive alloyed radiant tubes with longer life
viii. Improved feed conversion efficiency
ix. Higher Ammonia production potential

An estimated reduction in the CO₂ emissions is up to 12% of the base operating level along with the above listed advantages

For a similar reduction in CO₂ emissions, embodiment 4 of FIG. 5 needs less than 45% of the investment and the operating cost of the Electrolysis Hydrogen option with a much shorter project time frame to implement it. Also, the investment of the FIG. 5 embodiment compared to the option of using the CO₂ capture without accounting the cost of the sequestration (CCS) will be about the same or marginally higher with a shorter time frame of implementation.

As mentioned before, pre-reforming is well known and has already been commercially applied in the reforming applications. However, what is new and novel here is a combination of the pre-reforming reactor with electric heating of the feed of the pre-reformer and reuse of the process air coil for preheating the mixed feed for a maximum reduction in the firing and the associated CO₂ emissions from the primary reformer with minimum changes in the convection section to reduce the important plant turnaround time for its installation.

There are four additional embodiments to follow that all include the use of a pre-reformer in the mix and an additional embodiment with the use of external add-on heaters. These multiple embodiments in all of this disclosure are presented because the suitability of each of these embodiments will depend on the operating and the design conditions of the primary reformer, therefore different solutions or embodiments may be called for.

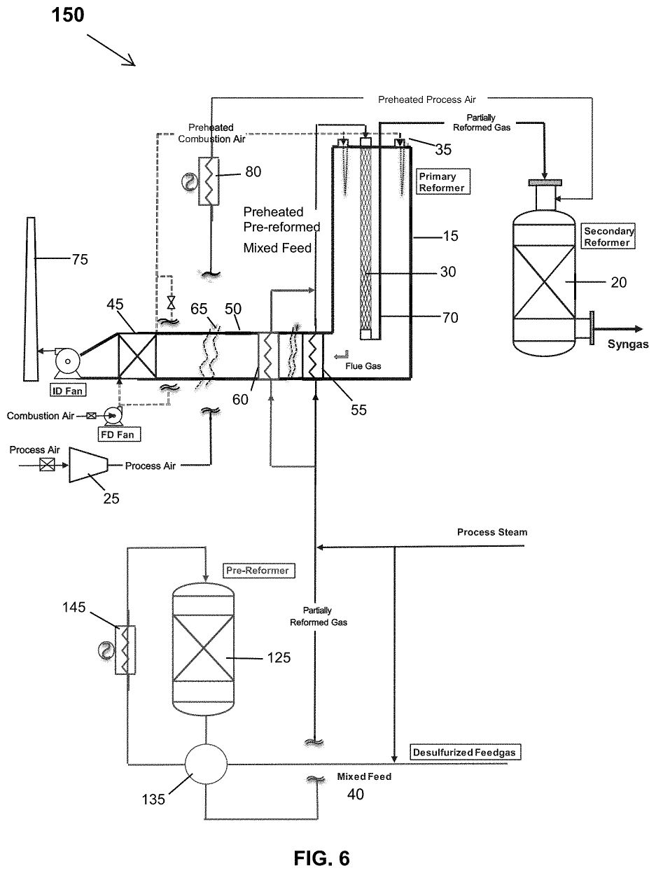

These additional pre-reformer embodiments using different applications of use of a pre-reformer described briefly in the Brief Description of the Drawings for FIGS. 6-9 provide the following benefits:
i. Reduced Reforming duty in the primary reformer
ii. Reduced Firing in Primary reformer
iii. Reduced Flue gas flow and CO₂ emissions
iv. Higher conversion of the feed gas to Syngas
v. Reduced outlet temperature of the Radiant Tubes in the Primary Reformer
vi. Steam saving with reduced steam to carbon ratio in the Primary Reformer without sacrificing the overall conversion of the feed gas at the outlet of the Secondary Reformer
vii. Cooler operation of the expensive alloyed radiant tubes with longer life
viii. Improved feed conversion efficiency
ix. Higher Ammonia production potential

An estimated reduction in the CO2 emissions is up to 12% of the base operating level along with the above listed advantages

For a similar reduction in CO2 emissions, the supplementary invention disclosure of FIGS. 6 to 9 need much less investment and a lower operating cost as compared to the Electrolysis Hydrogen option. These schemes can also be implemented in a relatively shorter project time frame.

The investment and the operating cost of these supplementary embodiments (in FIGS. 6 to 9) are also much less than the option of CO2 capture from the flue gases without accounting for the cost of sequestration (CCS).

### Embodiment 5

Referring now to FIG. 6 a fifth embodiment, shown generally as 150, is described in which a new catalytic pre-reformer with an accompanying new electric heater 145 for the light hydrocarbon and steam mixed feed as also shown in embodiment four, thereby again reducing the process load on the primary reformer, reducing firing and lowering the CO2 emissions.

In addition this embodiment includes the features of embodiment 2 (FIG. 3)—the addition of an electrical preheater 80 to preheat the process air to the secondary reformer and raising the temperature of the mixed feed 40 by partially or completely reusing or replacing the process air coil 60 in the convection section for additional preheating of the partially reformed plus the balance of the process steam as mixed feed being fed to the primary reformer. Together, this embodiment provides a much higher reduction in the firing and offloading of the primary reformer and reduction in the associated CO₂ emissions from the base operating level of the primary reformer. Note that a part of the combustion air may be bypassed around the air preheater 45 installed in the convection section of the Primary Reformer depending on pressure drop and operating conditions.

Again, as in FIG. 5 with a pre-reformer in the scheme, the process steam is usually split before and after the pre-reformer to minimize or optimize the catalyst volume/size of the pre-reformer.

### Embodiment 6

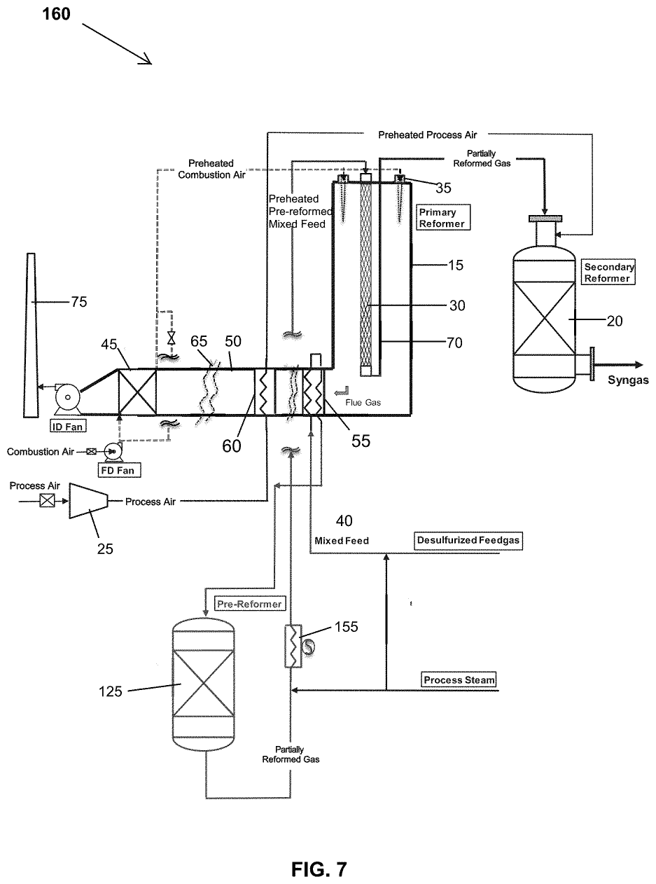

Referring now to FIG. 7, a sixth embodiment, shown generally as 160, is illustrated in which a new catalytic pre-reformer is again used with an electrical heater 155 used to preheat the mixture effluent stream from the pre-reformer and the balance of the process steam (up to 1200 deg F.) before it is fed to the catalytic tubes 30 of the primary reformer. The mixed feed convection coils 55 in the convection section are repurposed to provide additional heating of the mixed feed to the pre-reformer. Once again as in some of the previous embodiments the process steam is split before and after the pre-reformer to minimize or optimize the catalyst volume/size of the pre-reformer. Note that a part of the combustion air may be bypassed around the air preheater 45 installed in the convection section of the Primary Reformer depending on pressure drop and operating conditions.

### Embodiment 7

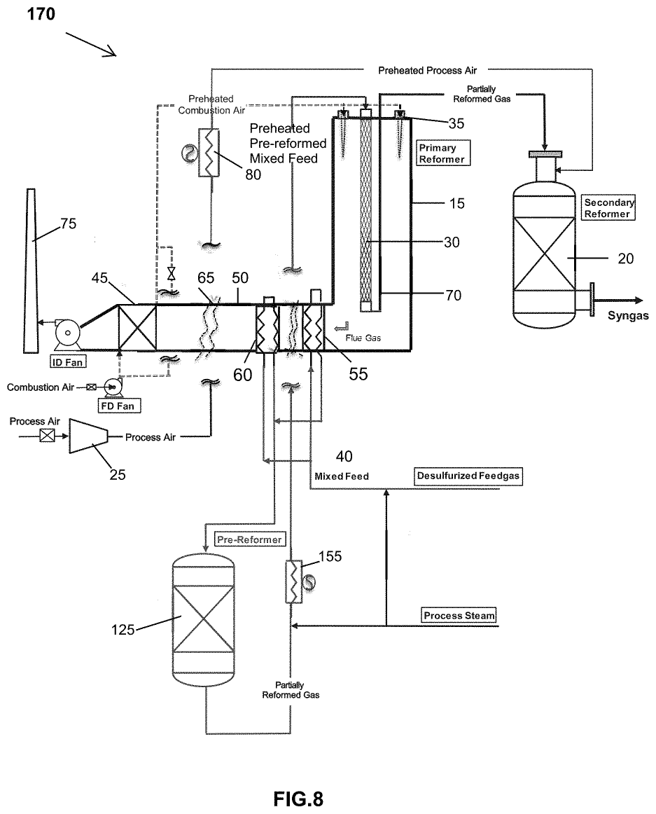

Referring now to FIG. 8, a seventh embodiment, shown generally as 170, is described in which a new catalytic pre-reformer is again used with electrical heating 155 of the effluent stream from the pre-reformer along with a mix of the balance of the process steam (up to 1200 deg F.) before it is fed to the primary reformer, and in this embodiment both the mixed feed preheat convection coils 55 in the convection section and the former process air convection coils 60 can been used and used to provide additional heating of the pre-reformer mixed feed. The mixed feed may be preheated with or without splitting its flow between the mixed feed coil and the process air coil along with a suitable flow bypass across the process air coil depending on the operating conditions, convection coils configurations and any other constraints in primary reformer. And the incoming process air from air compressor 25 is once again electrically heated (up to 1200 deg F.) by electric heater 80 before being fed to the secondary reformer. Once again as in some of the previous embodiments the process steam is split before and after the pre-reformer to minimize or optimize the catalyst volume/size of the pre-reformer. Note that a part of the combustion air may be bypassed around the air preheater 45 installed in the convection section of the Primary Reformer depending on pressure drop and operating conditions.

### Embodiment 8

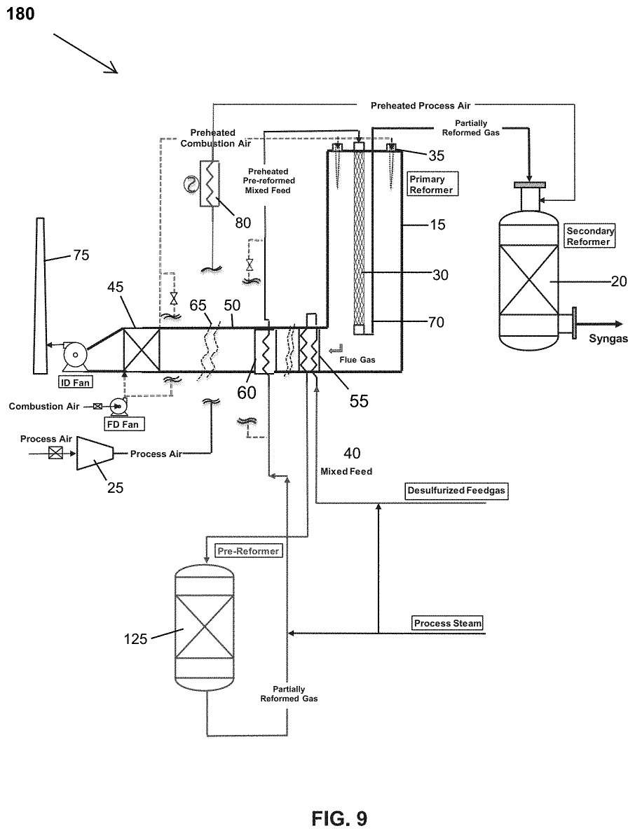

Referring now to FIG. 9, an eighth embodiment, shown generally as 180, is described in which a catalytic pre-reformer is again used and the Mixed Feed fed to the pre-reformer is preheated (up to 1200 deg F.) in the normal mixed feed convection coils 55 with an adjusted flow of the process steam, and then fed to the pre-reformer. An electric heater 80 is provided to heat the process air (up to 1200 deg F.) before feeding to the secondary reformer, and the normal process air convection coils 60 in the convection section are reused to preheat the effluent from the pre-reformer before it is fed to catalyst tubes 30 in the primary reformer. Once again as in some of the previous embodiments the process steam is split before and after the Pre-reformer to minimize or optimize the catalyst volume/size of the Pre-reformer. A part of the pre-reformed mixed feed flow may be bypassed across the former process air coil depending on the pressure drop and the operating conditions. Note that a part of the combustion air may be bypassed around the air preheater 45 installed in the convection section of the Primary Reformer depending on pressure drop and operating conditions.

### Embodiment 9

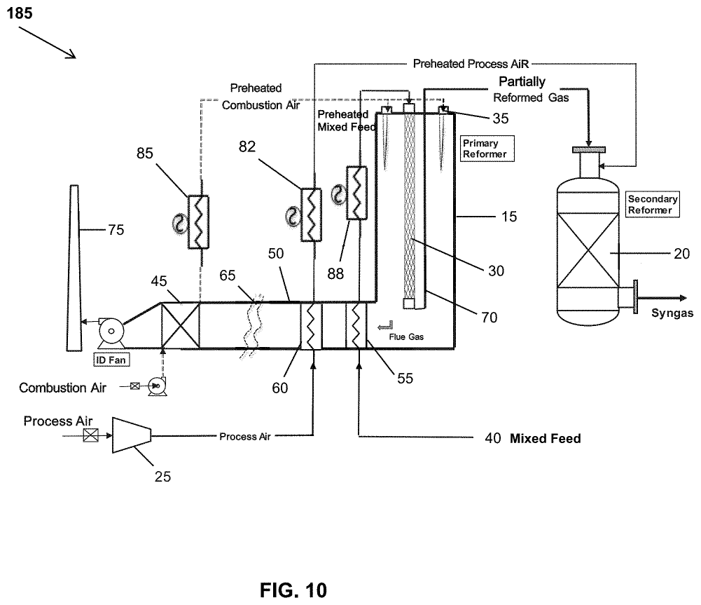

Referring now to FIG. 10, a ninth, and last, embodiment, shown generally as 185, is described. This embodiment includes the addition of electric heater 88 to further heat (up to 1200 deg F.) the preheated mixed feed stream coming out from the mixed feed convection coils 55 and another electric heater 82 to further heat up (to 1200 deg F.) the preheated process air stream coming out from the process air convection coils.

An optional addition of electric heater 85 in the preheated combustion air stream coming out of the Air Preheater as also shown in embodiment 1 (FIG. 2).

The electric heaters can be added in both the mixed feed stream and the process air stream or only one of them depending on the configuration and operating conditions of the Primary Reformer. The suitability of adding an electric heater for additional preheating of the combustion air is optional and may be added based on the site-specific design and operating conditions of the Primary Reformer. The electric heaters can be separate devices for each of the streams to be preheated or they may be combined in a common single enclosure.

The electric heaters can be separate devices for each of the streams to be preheated or they may be combined in a common single enclosure for space and cost savings.

The various embodiments presented in this disclosure represent a significant step forward in the novelty of methods and apparatus that contribute to reducing the firing and carbon dioxide emissions in installed or new synthesis gas production units. Some of the contributions include:
Repurposing of the Process Air convection coil (along with its preheat via an external electric heater) as an additional mixed feed preheat coil to raise the temperature of mixed feed in a mostly space and heat-sink constraint convection section permits reduced firing and CO2 emissions with much simpler modifications with least Capex and Opex and with minimum impact on the heat recovery of other streams used in the convection coil
Use of new Electrical heaters for either the process air or mixed feed or the combustion air allows maximization of preheat temperature of those streams without any heat limiting constraints
Combination of pre-reformer in combination with repurposed process air coil for mixed feed preheat along electrical heater permits minimizing the reformer firing with minimum impact on the heat recovery of other streams used in the convection coil

The present invention has been described with reference to specific details of particular embodiments. It is not intended that such details be regarded as limitations upon the scope of the invention except insofar as and to the extent that they are included in the eventual presented claims.

1. A method for reducing the firing and carbon dioxide emissions in installed or new synthesis gas production units comprising a catalytic primary reformer and catalytic secondary reformer, the method comprising:
a. providing multiple direct fired tubes within the primary reformer filled with a catalyst being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. the hot flue gases leaving the radiant section of the primary reformer routed to pass through an adjoining convection section for heat recovery by preheating other process streams, including the mixed feed of natural gas, hydrogen and steam to be fed to the catalytic tubes in the radiant section of the primary reformer, and a stream of pre-heated process air to be fed to the secondary reformer by passing them through a number of convection coils located in the convection section;
d. wherein the partially reformed synthesis gas exiting the catalytic primary reformer is fed to the secondary reformer along with the preheated process air, to produce reformed synthesis gas, the method further comprising:
e. providing an additional electric heater for further preheating of the combustion air feeding into the burners within the radiant section of the primary reformer.

2. A method for reducing the firing and carbon dioxide emissions in installed or new synthesis gas production units comprising a catalytic primary and catalytic secondary reformer, with multiple direct fired tubes filled with a catalyst inside a refractory lined radiant section within the primary reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. wherein the mixed feed of natural gas, hydrogen, and steam being fed to the multiple direct fired tubes filled with a catalyst inside the primary reformer is split into two streams, to preheat part of the mixed feed through its normal convection coils located in the convection section and heating the remaining part of the mixed feed through the convection coils located in the convection section normally used to preheat the process air being fed to the secondary reformer; and further comprising:
d. providing an electric heater for preheating the process air being fed to the secondary reformer along with the partially reformed gas from the primary reformer to produce synthesis gas.

3. The method for reducing the firing and carbon dioxide emissions in installed or new synthesis gas production units of claim 2 further comprising:
a. providing an additional electric heater for further preheating of the combustion air feeding into the burners within the radiant section of the primary reformer.

4. A method for reducing the firing and carbon dioxide emissions in installed or new synthesis gas production units comprising a catalytic primary reformer, a catalytic secondary reformer and a catalytic pre-reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. with the hot flue gases leaving the radiant section of the primary reformer routed to pass through an adjoining convection section for heat recovery by preheating other process streams, including the mixed feed of natural gas, hydrogen and steam to be fed to the catalytic tubes in the radiant section of the primary reformer, and a stream of pre-heated process air to be fed to the secondary reformer by passing them through a number of convection coils located in the convection section;
d. wherein the partially reformed gases leaving the catalytic primary reformer catalyst tubes are fed to the secondary reformer along with the preheated process air where the secondary catalytic reforming produces synthesis gas;
e. wherein some of the steam supplied as part of the mixed feed for synthesis gas production is split before and after the pre-reformer to optimize catalyst performance in the pre-former; the method further comprising:
f. providing an electric preheater to preheat the resulting mixed feed to the catalytic pre-reformer.

5. A method for reducing the firing and carbon dioxide emissions in installed or new synthesis gas production units comprising a catalytic primary reformer, a catalytic secondary reformer and a catalytic pre-reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. wherein the mixed feed of natural gas, hydrogen and steam being fed to the multiple direct fired tubes filled with a catalyst inside the primary reformer is split into two streams, to heat part of the mixed feed through its normal convection coils located in the convection section and heating the remaining part of the mixed feed through the convection coils located in the convection section normally used to preheat the process air being fed to the secondary reformer;
d. wherein the partially reformed gases leaving the catalytic primary reformer catalyst tubes are fed to the secondary reformer along with the preheated process air where the secondary catalytic reforming produces synthesis gas;
e. wherein some of the steam supplied as part of the mixed feed for synthesis gas production is split before and after the pre-reformer to optimize catalyst performance in the pre-former; the method further comprising:
f. providing an electric preheater to preheat the resulting mixed feed to the catalytic pre-reformer.

6. A method for reducing the firing and carbon dioxide emissions in installed or new synthesis gas production units comprising a catalytic primary reformer, a catalytic secondary reformer and a catalytic pre-reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. wherein the mixed feed of natural gas, hydrogen and steam is preheated in the mixed feed convection coils and then fed to the catalytic pre-reformer and the pre-reformer effluent is heated with an added electric heater before being fed to the catalytic tubes in the radiant section of the primary reformer;
d. and the partially reformed gases leaving the catalytic primary reformer catalyst tubes are fed to the secondary reformer along with the preheated process air, where the secondary catalytic reforming produces synthesis gas;
e. wherein some of the steam supplied as part of the mixed feed for synthesis gas production is split before and after the pre-reformer to optimize catalyst performance in the pre-former.

7. A method for reducing the firing and carbon dioxide emissions in installed or new synthesis gas production units comprising a catalytic primary reformer, a catalytic secondary reformer and a catalytic pre-reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. wherein the mixed feed of natural gas, hydrogen, and steam being fed to the synthesis gas system split into two streams and one is fed into the mixed feed preheat convection coils and the second is fed into a set of repurposed convection coils provided in the former process air convection coils and both are then mixed to be fed to the catalytic pre-reformer and after being pre-reformed, the pre-reformer effluent is preheated with an added electric heater before being fed to the catalytic tubes in the radiant section of the primary reformer;
d. and the reformed gases leaving the catalytic primary reformer catalyst tubes are fed to the secondary reformer along with the preheated process air, where the secondary catalytic reforming produces synthesis gas;
e. wherein some of the steam supplied as part of the mixed feed for synthesis gas production is split before and after the pre-reformer to optimize catalyst performance in the pre-former; and further comprising:
f. adding an electrical heater to the preheated process air being fed to the secondary reformer.

8. A method for reducing the firing and carbon dioxide emissions in installed or new synthesis gas production units comprising a catalytic primary reformer, a catalytic secondary reformer and a catalytic pre-reformer; the method comprising:
a. providing multiple direct fired tubes filled with catalyst inside a refractory lined radiant section within the primary reformer being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. wherein the mixed feed of natural gas, hydrogen, and steam being fed to the synthesis gas system is fed into the mixed feed preheat convection coils and then fed to the catalytic pre-reformer and wherein the effluent of the partially reformed gases from the pre-reformer are then preheated by feeding them into the convection coils in the convection section formally used to preheat process air to the catalytic secondary reformer; and are then fed to the catalytic tubes in the radiant section of the primary reformer for further reforming; and the further reformed gas from the catalytic primary reformer is fed along with preheated process air to the catalytic secondary reformer where secondary catalytic reforming produces synthesis gas; and further comprising:
d. adding an electrical heater to preheat process air being fed to the secondary reformer.

9. A method for reducing the firing and carbon dioxide emissions in installed or new synthesis gas production units comprising a catalytic primary reformer and catalytic secondary reformer, the method comprising:
a. providing multiple direct fired tubes within the primary reformer filled with a catalyst being fed a preheated mixed feed of natural gas, hydrogen, and steam;
b. the primary reformer radiant section being heated by burners within the radiant section within the primary reformer, the burners being fed a fuel gas mixed with preheated combustion air, preheated by an air preheater installed in the convection section of the primary reformer;
c. the hot flue gases leaving the radiant section of the primary reformer routed to pass through an adjoining convection section for heat recovery by preheating other process streams, including the mixed feed of natural gas, hydrogen, and steam, and a stream of pre-heated process air to be fed to the secondary reformer by passing them through a number of convection coils located in the convection section;
d. wherein the partially reformed synthesis gas exiting the catalytic primary reformer is fed to the secondary reformer along with the preheated process air, to produce reformed synthesis gas, the method further comprising:
e. providing an electric heater to further preheat the preheated mixed feed stream coming from the mixed feed convection coils;
f. providing an electric heater to further preheat the preheated process air stream coming out of the process air convection coils.

10. The method for reducing the firing and carbon dioxide emissions in installed or new synthesis gas production units comprising a catalytic primary reformer and catalytic secondary reformer of claim 9: further comprising providing an electric heater to further preheat the preheated combustion air coming from the combustion air preheater.
